(19) United States
(12) Patent Application Publication
(10) Pub. No.: US 2012/0320383 A1
(43) Pub. Date: Dec. 20, 2012

(54) Enclosed Laser-Ultrasonic Inspection System

(76) Inventors: Marc Dubois, Keller, TX (US); Thomas E. Drake, Fort Worth, TX (US)

(21) Appl. No.: 13/523,027

(22) Filed: Jun. 14, 2012

Related U.S. Application Data
(60) Provisional application No. 61/496,852, filed on Jun. 14, 2011.

(51) Int. Cl. G01N 29/04; G01H 9/00

(52) U.S. Cl. 356/502

(57) ABSTRACT

A laser ultrasonic inspection system comprises laser sources configured to generate laser beams, an optical scanner configured to direct the laser beams onto an object thereby generating ultrasonic waves in the object and illuminating the object, an interferometer configured to generate an electrical signal in response to the reflected light, and a radiation restricting inspection chamber for housing the object. Another laser ultrasonic inspection system comprises a radiation restricting inspection chamber, laser sources located outside of the inspection chamber, an optical scanner located inside the inspection chamber, a visible laser tracer representative of the orientation of the laser beams; an interferometer, a scanner positioning mechanism, and an object positioning mechanism. A method for inspecting an object comprises the steps of positioning an object inside of an inspection chamber, defining a scanning profile, and directing laser beams onto the object according to the inspection profile.

### CROSS-REFERENCE TO RELATED APPLICATIONS

This application claims priority to U.S. Provisional Patent Application No. 61/496,852, entitled ENCLOSED LASER-ULTRASONIC SYSTEM FOR INDUSTRIAL APPLICATIONS, filed Jun. 14, 2011, which is hereby incorporated by reference for all purposes.

### BACKGROUND OF THE INVENTION

Polymer-matrix composites are increasingly used in the aeronautics industry. Along with the volume of composite parts, the shape complexity of the parts is increasing as well. All composite parts must be inspected and ultrasonic testing has been demonstrated as the best technique for this inspection. However, ultrasonic testing of complex-shape composites is slow and expensive using water-based conventional techniques.

For large complex-shape composite parts, conventional water-based ultrasonic systems designed for a specific type of parts are used. Those systems still require a lot of part preparation and programming before each inspection. An alternative to those specifically-designed systems is the laser-ultrasonic technology. A single laser-ultrasonic system can inspect a large variety of part shapes. Laser-ultrasonic systems require a closed room to protect personnel from exposure to laser radiation. For large composite parts, a specific room is acceptable considering the large footprint required to inspect the part in the first place, and the relative cost of the inspection systems. Even non-laser inspection systems have relatively large footprints and high costs.

For small composite parts, the space and labor required by automated water-based systems make those systems unsuitable due to the large variety of shapes and sizes. The only alternative is manual scanning using piezo-electric transducers. Manual scanning is slow, labor intensive, and does not provide a permanent record of the inspection results.

Laser-ultrasonic is an alternative to manual scanning However, the cost and space required by a laser-protection room prevents its economical use for small parts.

### SUMMARY

Embodiments of the present disclosure generally provide a laser ultrasonic inspection system, and a method for inspecting an object.

The present disclosure is directed to a laser ultrasonic inspection system, comprising a first and a second laser source configured to generate a first and a second laser beam; an optical scanner configured to direct the first and second laser beams onto an object to be inspected; an interferometer optically coupled to the optical scanner, the interferometer configured to receive light reflected by the object and to generate an electrical signal in response to the reflected light; and an inspection chamber for housing the object to be inspected, the inspection chamber configured to restrict outside exposure to radiation from the first and second laser beams; wherein the first laser beam generates ultrasonic waves in the object and the second laser beam illuminates the object. In an embodiment, laser ultrasonic inspection system further comprises a controller configured to control the optical scanner to direct the first and second laser beams.

In various embodiments, laser ultrasonic inspection system further comprises a scanner positioning mechanism to which the optical scanner is coupled, the scanner positioning mechanism configured to movably position the optical scanner within the inspection chamber. In an embodiment, inspection system comprises a controller configured to control the position of the optical scanner within the inspection chamber via the positioning mechanism.

In various embodiments, the inspection chamber comprises an aperture for viewing the interior of the chamber. In an embodiment, the aperture comprises a window. In another embodiment, the inspection chamber further comprises a camera for viewing the interior of the chamber. In various embodiments, inspection chamber comprises an object support structure for supporting the object to be inspected. In an embodiment, the object support structure comprises one or more visual indicators to assist in positioning the object thereon.

In various embodiments, laser ultrasonic inspection system further comprises an object positioning mechanism within the inspection chamber. In an embodiment, inspection system further comprises a controller configured to control the position of the object positioning mechanism.

In various embodiments, inspection system further comprises a controller configured to automatically control the optical scanner to direct the first and second laser beams, the position of the optical scanner within the inspection chamber via the positioning mechanism, and the position of the object positioning mechanism according to a programmed scanning profile. In an embodiment, the optical scanner is configured to direct a visible laser tracer, the visible laser tracer being representative of the orientation of the first and second laser beams as directed by the optical scanner. In another embodiment, all or part of a scanning profile is defined according to real-time user inputs to a controller configured to control the optical scanner, the position of the optical scanner, and the position of the object positioning system, the real-time user inputs being guided with the assistance of a visible laser tracer representative of the orientation of the first and second laser beams as directed by the optical scanner. In yet another embodiment, a ratio of an interior volume of the inspection chamber to a scan volume is less than 20.

In another aspect, the present disclosure is directed to a laser ultrasonic inspection system, comprising an inspection chamber for housing the object to be inspected, the inspection chamber configured to restrict outside exposure to radiation from the first and second laser beams; a first and a second laser source configured to generate a first and a second laser beam, the first and the second laser sources being disposed outside of the inspection chamber, wherein the first laser beam generates ultrasonic waves in the object and the second laser beam illuminates the object; an optical scanner configured to direct the first and second laser beams onto the object to be inspected, the optical scanner being disposed within the inspection chamber; a visible laser tracer representative of the orientation of the first and second laser beams; an interferometer optically coupled to the optical scanner, the interferometer configured to receive light reflected by the object and to generate an electrical signal in response to the reflected light; a scanner positioning mechanism configured to movably position the optical scanner within the inspection chamber; and an object positioning mechanism configured to movably position the object within the inspection chamber.

In another aspect, the present disclosure is directed to a method for inspecting an object, comprising the steps of positioning an object inside of an inspection chamber; defining a scanning profile, comprising the sub-steps of defining one or more scan areas; and defining one or more positions for an optical scanner; and directing a first and a second laser beam onto the object according to the scanning profile.

In an embodiment, the step of defining a scanning profile comprises selecting a pre-programmed scanning profile. In another embodiment, the scanning profile is defined according to real-time user inputs to a controller configured to control the optical scanner and the one or more positions of the optical scanner, the real-time user inputs being guided with the assistance of a visible laser tracer representative of the orientation of the first and second laser beams as directed by the optical scanner. In yet another embodiment, the step of defining a scanning profile comprises selecting one or more scanning parameters from a user-selectable list. In yet a further embodiment, the one or more scanning parameters may be selected from the group consisting of: scan area, scan pattern, optical scanner position, optical scanner head orientation, and object position.

In an embodiment, the step of defining a scanning profile comprises the additional sub-step of defining a scan pattern. In another embodiment, the step of defining a scanning profile comprises the additional sub-step of defining one or more orientations of the optical scanner. In yet another embodiment, the step of defining a scanning profile comprises the additional sub-step of defining one or more positions for the object. In yet a further embodiment, a ratio of an interior volume of the inspection chamber to a scan volume is less than 20.

Other technical features may be readily apparent to one skilled in the art from the following figures, descriptions and claims.

### BRIEF DESCRIPTION OF THE DRAWINGS

For a more complete understanding of the features, example embodiments and possible advantages of the present invention, reference is now made to the detailed description of the invention along with the accompanying figures and in which:

FIG. 1 depicts a perspective view of a laser ultrasonic inspection system according to an embodiment of the present disclosure;

FIG. 2 depicts a schematic view of a laser ultrasonic scanning system according to an embodiment of the present disclosure;

FIG. 3 depicts a schematic view of a scan area projected by an optical scanner according to an embodiment of the present disclosure;

FIG. 4 depicts a side cutaway view of an inspection chamber of a laser ultrasonic inspection system according to an embodiment of the present disclosure;

FIG. 5A depicts a side cutaway view of an optical scanner in multiple positions about an object in an inspection chamber according to an embodiment of the present disclosure; and

FIG. 5B depicts the inspection chamber of FIG. 5A wherein the object has been repositioned by a rotation table according to an embodiment of the present disclosure.

### DETAILED DESCRIPTION OF THE INVENTION

Embodiments of the present disclosure generally provide a laser-ultrasonic inspection system for inspecting composite objects. As described herein, the laser-ultrasonic inspection system comprises an optical scanner for directing laser beams at an object inside an inspection chamber. In various embodiments, exposure to laser radiation emitted by components located inside of and outside of the inspection chamber may be limited by the inspection chamber and other shielding such that laser ultrasonic inspection system need not be located in a dedicated room equipped with laser safety features. In various embodiments, the optical scanner is moveably positioned about the chamber, and the object may be reoriented to facilitate comprehensive inspection.

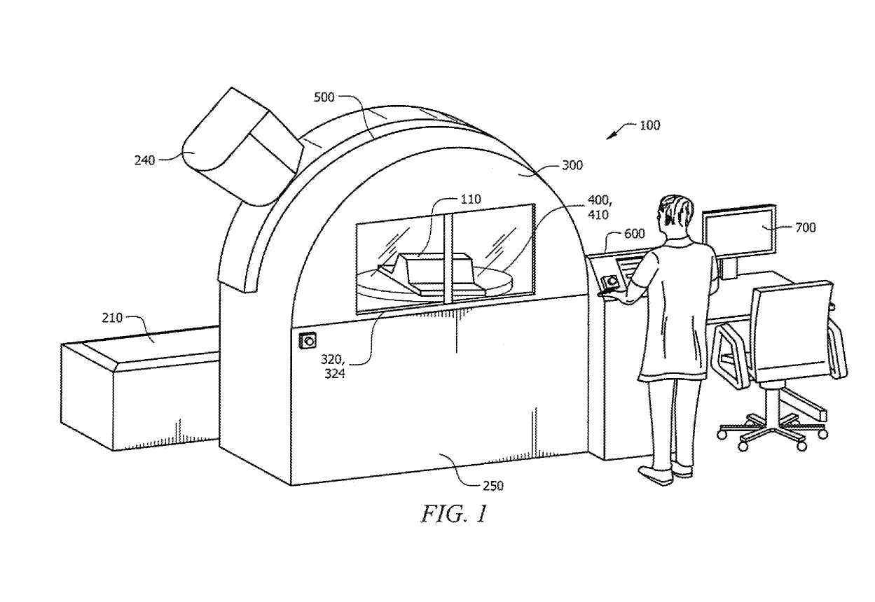

FIGS. 1-5B illustrate representative configurations of laser ultrasonic inspection system 100 and parts thereof. It should be understood that the components of laser ultrasonic inspection system 100 and parts thereof shown in FIGS. 1-5B are for illustrative purposes only, and that any other suitable components or subcomponents may be used in conjunction with or in lieu of the components comprising laser ultrasonic inspection system 100 and the parts of laser ultrasonic inspection system 100 described herein.

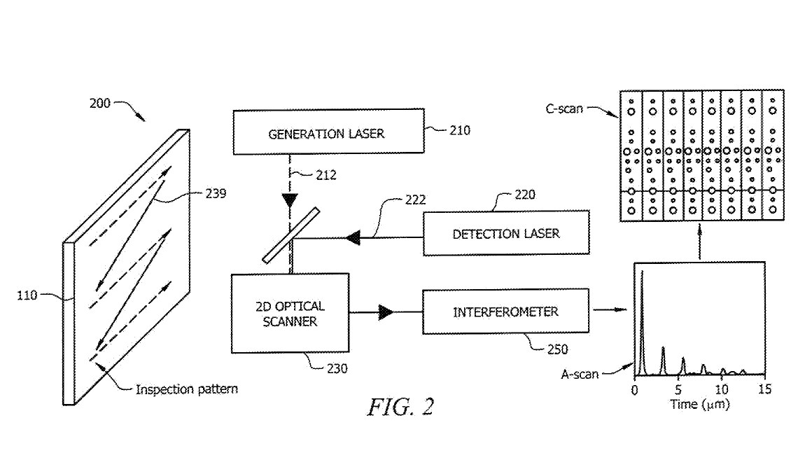

FIG. 1 depicts a perspective view of a laser ultrasonic inspection system 100. Laser ultrasonic inspection system 100 may generally comprise a laser ultrasonic scanning system 200 (schematically depicted in FIG. 2), an inspection chamber 300, an object positioning mechanism 400, an optical scanner positioning mechanism 500, and a controller 600.

Referring to FIGS. 1 and 2, laser ultrasonic scanning system 200 may comprise any suitable laser ultrasonic scanning components known in the art. In an embodiment, scanning system 200 may generally comprise a first laser source 210, a second laser source 220 (not shown), an optical scanner 230, a scanning module 240, and interferometer 250. First and second laser sources 210, 220 may be configured to generate a first and second laser beam 212, 222, respectively. First laser beam 212, known as a generation laser beam, may create ultrasonic waves in an object 110 on which it is directed. Example generation lasers include, but are not limited to, CO₂ lasers, YAG lasers, mid-IR lasers, and excimer lasers. Second laser beam 222, known as a detection laser beam, may illuminate the object. In an embodiment, second laser beam 222 may illuminate the object with a probing light. Example detection laser sources 220 include, but are not limited to, Nd:YAG lasers, Yb:YAG lasers, and Argon lasers. In various embodiments, detection laser source 220 may be lamp-pumped or diode pumped, in various configurations like rods, slabs, or fibers. In another embodiment, detection laser source 220 may be in a master-oscillation power amplifier configuration with a seed laser. The seed laser may comprise a non-planar ring oscillator, a fiber laser, or any other single-frequency source suitable to interferometric measurements. The amplifier may comprise at least one lamp-pumped rod, at least one diode-pumped slab, or at least one fiber-laser amplifier stage, or any combination of thereof

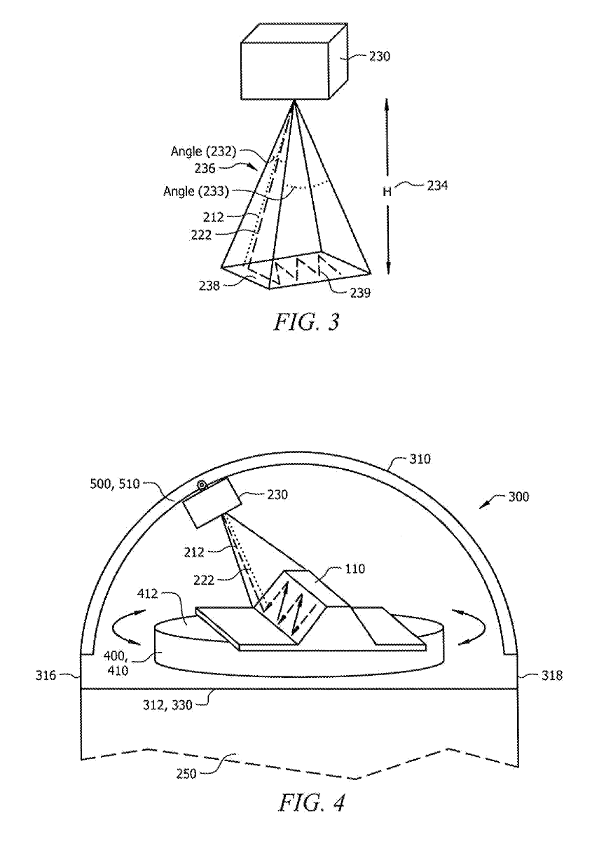

Each laser source 210, 220 may be optically coupled to optical scanner 230. Examples of optical scanners 230 include, but are not limited to, two-mirror galvanometers and single-mirror-mounted on a two-axis rotation mechanism (gimbals). A scanning module 240 may contain optical elements for laser beam conditioning known in the art. Referring to FIG. 3, optical scanner 230 may be configured to direct each beam 212, 222 onto an object 110. In an embodiment, optical scanner 230 may vary the angles 232, 233 of laser beams 212, 222, effectively defining a scan volume 236 having a scan area 238 at a distance 234 from the scanner 230. Stated otherwise, distance 234 and scan area 238 may be used to calculate the maximum scan volume occupied by laser beams 212, 222. In one embodiment, optical scanner may direct beams 212, 222 so as to form a pyramid-shaped scan volume 236, the rectangular base of the pyramid forming the scan area 238. In an embodiment, scan area 238 may be normal to the general orientation of the scan volume 236, that is, normal to an imaginary line that extends from scanner 230 and bisects each of angles 232, 233. A pyramid-shaped scan volume 236 (Vₛ) could be calculated by the equation, V_{S}=⅓BH, where B is the scan area 238, and H is the distance 234. One having ordinary skill in the art will recognize that beams 212, 222 may be directed at any suitable number and combination of angles to form any suitable scan area 238 and corresponding scan volume 236. Likewise, a suitable equation or numerical technique may be used to calculate the scan volume 236 of any such variation, and thereby provide for optimizing the scan area 238 and distance 234 for a given application. Beams 212, 222 may be directed to form any suitable scan pattern 239 on scan area 238. Distance 234 may correspond with the optimum distance between the scanner and the object as per the specification of the laser-ultrasonic system.

In one embodiment, first or second laser 210 and 220, or both, might be equipped with a visible laser tracer that indicates where laser beams 212 and 222 would hit the object even when lasers 210 and 220 are not in operation. A separate visible laser tracer can also be inserted in the optical path of either laser beams 212 or 220. The visual indication provided by the visible laser tracer on object 110 can be used by the operator to define scanning profiles that consists of position of scanner 230, position of object 110, and scanning pattern 239.

In operation, part of second laser beam 222 may be reflected by object 110, and may be phase shifted by the ultrasonic waves induced in object 110 by first laser beam 212. Reflected portions of second laser beam 222 may be gathered by optical scanner 230 and optics within scanning module 240, and directed to interferometer 250 optically coupled thereto. Interferometer 250 may transform phase or frequency modulations in the reflected light into electrical signals. In an embodiment, the interferometer 250 may generate an ultrasonic signal responsive to the phase shift in the reflected portions of second laser beam 222. Example interferometers 250 include, but are not limited to, single or dual cavity Fabry-Perot, Michelson, photorefractive, Sagnac, and Mach-Zender interferometers.

Referring now to FIG. 4, inspection chamber 300 may comprise any continuous volume structure of any suitable shape and interior dimensions. In an embodiment, inspection chamber 300 may comprise an arch-like volume having a top surface 310, a bottom surface 312, and side surfaces 314 (not shown). Inspection chamber 300 may be further described as having a first end 316 and a second end 318. One having ordinary skill in the art will recognize that inspection chamber 300 may be of any suitable shape, and is not limited to that of the previously described embodiment. In various embodiments, inspection chamber 300 may be limited in size. In one embodiment, inspection chamber 300 may only be sized to house object 110 and optical scanner 230 within the chamber in order to reduce the amount of space occupied by scanning system 200. In another embodiment, the ratio (R_{V}) of the interior volume of inspection chamber 300 (V_{C}) to the scan volume 236 (V_{S}), i.e., R_{V}=V_{C}/V_{S}, less than 20. Laser ultrasonic inspection system 100 with Rᵥ less than 20 may occupy less floor space than other designs, which often require a dedicated room in which to operate, yet still accommodate a large variety of smaller parts.

In an embodiment, chamber 300 may comprise any suitable material capable of at least partially containing radiation emitted by laser beams 212, 222. In some embodiments, direct laser beams 212, 222 and their reflections may emit radiation at levels above those permissible to direct human exposure (above 5mW per square centimeter for example). The level of permissible human exposure is typically defined by local regulations and can vary from one region to the other. In an embodiment, inspection chamber 300 comprises adequate shielding material(s) such that laser-ultrasonic inspection system may be located in any suitable location of a plant without the need of a special room equipped with laser safety features, and without the need for the operators and other employees to wear personal laser safety equipment. In another embodiment, laser-ultrasonic inspection system may be relocated very rapidly and economically because it does not require a special room for safe operation. The size of the inspection chamber in the present invention in comparison to the scan volume is significantly smaller than those of prior art laser-ultrasonic systems. In prior art laser-ultrasonic systems, the inspection chamber is a room in which the operator can enter. In those systems, the size of the inspection chamber can be hundred of times larger than a single scan volume.

The shape of inspection chamber 300, mechanism 500, and mechanism 400 should be such that the distance between scanner 230 and the inspected area on object 110 is close to optimum distance 234, or at least within the acceptable distance range for optimum laser-ultrasonic measurements, and within the acceptable incidence angles.

Referring back to FIG. 1, inspection chamber 300 may further comprise any suitable opening 320 for accessing its interior. In various embodiments, opening 320 is large enough to insert and remove an object 110 from the chamber 300. Opening 320, or any other suitable portion of chamber 300, may further comprise a viewing aperture 324 for viewing the interior of chamber 300 from the exterior. In an embodiment, inspection chamber 300 comprises a door having one or more windows. Windows may be comprised of any material suitable for at least partially containing radiation emitted by laser beams 212, 222 while being substantially transparent to most visible wavelengths. In another embodiment, inspection chamber 300 may further comprise one or more cameras (not shown) disposed within chamber 300 in connection with one or more displays disposed outside of chamber 300 for viewing the interior of chamber 300. Referring back to FIG. 4, chamber 300 may further comprise one or more support structures 330 suitable for supporting an object 110 within chamber 300. In one embodiment, support structure 330 may simply comprise the bottom surface 312 of inspection chamber 300. In another embodiment, support structure 330 may comprise one or more mounting poles (not shown), possibly similar to those used to support aircraft models in wind tunnels. It should be recognized that support structure 330 need not be limited to a surface or to the illustrative embodiments described herein, but may comprise any other suitable structure for supporting and/or holding an object 110 within chamber 300. Laser ultrasonic inspection system 100 may further comprise an object positioning mechanism 400 for adjusting the position and/or orientation of an object 110 coupled thereto within chamber 300. In one such embodiment, object positioning mechanism 400 comprises a rotation table 410 having a rotatable surface 412 on which an object 110 may be rotationally reoriented. Object positioning mechanism 400 may also provide for horizontal and/or vertical translation and for pan and/or tilt of an object 110 within the chamber 300. One having ordinary skill in the art will recognize that object positioning mechanism 400 may be embodied in multiple forms, and should not be limited only to the illustrative embodiments described herein. In various embodiments, support structure 330 and/or object positioning mechanism 400 may comprise visual or other sorts of positioning indicators to assist an operator in properly positioning an object 110 within the chamber 300 for inspection. For example, visual markers may be drawn, taped, and/or etched on chamber bottom 312 or on surface 412 of rotation table 410 to designate an optimal position and orientation for an object 110 thereon.

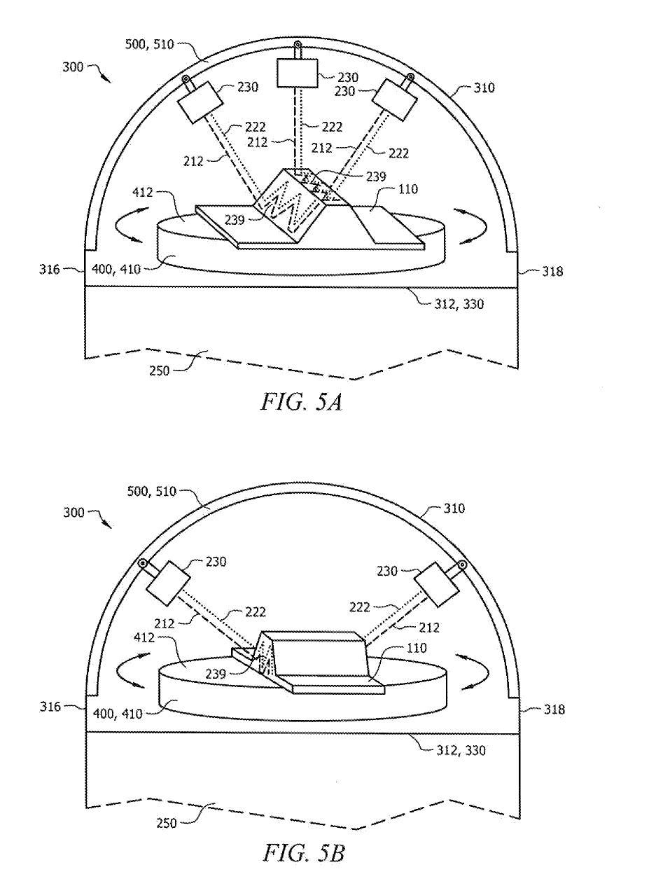

Referring now to FIGS. 5A and 5B, laser ultrasonic inspection system 100 may further comprise an optical scanner positioning mechanism 500. Optical scanner positioning mechanism 500 may comprise any suitable apparatus configured to position optical scanner 230 at various positions within inspection chamber 300. In various embodiments, scanner positioning mechanism 500 may comprise a motorized track mechanism 510 on which optical scanner 230 may translate between one or more positions along the track. In an embodiment, scanner positioning mechanism 500 may be coupled with or integrated into a surface of chamber 300, such as top surface 310. In another embodiment, track 510 may be disposed along top surface 310 and extend substantially between first end 316 and second end 318. FIG. 5A schematically depicts optical scanner 230 projecting laser beams 212, 222 in a scan pattern 239 onto an object 110 from three possible sequential scanning positions according to an embodiment of the present disclosure. FIG. 5B depicts optical scanner 230 scanning an object 110 from multiple positions as in FIG. 5A, and further shows how object positioning mechanism 410 (here, a rotation table 412) may reposition object 110 so that it may be scanned from yet another alternative angle (here, scanning the side portions of the object 110). One having ordinary skill in the art will recognize that scanner positioning mechanism 500 as described herein may be embodied by a multitude of apparatuses known in the art, and should not be limited to only the embodiments described herein. It should be further understood that optical scanner positioning mechanism 500 is not limited to movement within a single degree of freedom, but rather may position optical scanner 230 at any suitable position within chamber 300.

Components of laser ultrasonic scanning system 200 may be arranged in any manner suitable to scan an object 110 within chamber 300. In various embodiments, most components of scanning system 200 are disposed outside of chamber 300, while optical scanner 230 may be disposed inside. In one embodiment, first and second laser sources 210, 220 are located outside inspection chamber 300 and are optically coupled to the scanner 230. In an embodiment, optical coupling of one or more of laser sources 210, 220 with optical scanner 230 may be achieved using a series of articulated tubes joined by rotating joints equipped with mirrors. In another embodiment, an optical fiber may optically couple one or more of the laser sources 210, 220 with scanner 230. In yet another embodiment, first laser source 210 is optically coupled with scanner 230 by a series of articulated tubes joined by rotating joints equipped with mirrors, and second laser source 220 is optically coupled with scanner 230 by an optical fiber. One having ordinary skill in the art will recognize that any suitable mechanism or combination of mechanisms may be used to optically couple first and second laser sources 210, 220 with optical scanner 230, and that the present disclosure should not be limited to the aforementioned examples.

Referring back to FIG. 1, in various embodiments, optical scanner 230 and scanning module 240 may be physically coupled with scanner positioning device 500 such that scanning module 240 is disposed outside of chamber 300, and optical scanner 230 is disposed inside of chamber 300. In an embodiment, both optical scanner 230 and scanning module 240 may be moved together by scanner positioning device 500. First laser source 210, second laser source 220, and interferometer 250 may be optically coupled with optical scanner 230 by any suitable mechanisms. In an embodiment, portions of optical couplings located outside of the chamber 300 are shielded to restrict radiation exposure. In another embodiment, all or parts of one or more of laser sources 210, 220 may be physically coupled with and move with optical scanner 230. In some embodiments, arranging inspection system 100 with some components of system 200 outside of chamber 300 may provide a number of benefits including, but not limited to, a reduction in size of chamber 300, a reduction in component weight to be supported and moved by chamber 300 and scanner positioning mechanism 500, respectively, and enhanced accessibility to scanning system 200 components located outside of the chamber. System 100 may further comprise one or more analysis stations for analyzing various inspection data collected by interferometer 250.

Laser ultrasonic inspection system 100 may comprise a controller 600. Controller 600 may comprise any suitable hardware and software configured to control the operation of inspection system 100. Controller 600 may direct system 100 to execute an inspection according to a predetermined series of sequential instructions, also known as a scanning profile. Controller 600 may issue commands to operate various components of laser ultrasonic scanning system 200, as well as to maneuver optical scanner 230 via scanner positioning mechanism 500 and position object 110 via object positioning device 400. In various embodiments, controller 600 may compute a scanning profile as a function of various scanning parameters including, but not limited to, scan area, scan pattern (such as a raster), scanner position, object position/orientation, and sequential combinations thereof throughout an inspection. In one embodiment, controller 600 may store pre-programmed user profiles for selection by a user. In another embodiment, controller 600 may comprise a user interface for receiving user inputs corresponding to various scan parameters. In one such embodiment, controller 600 may comprise a user interface configured to display user-selectable lists, icons, or direct-entry fields associated with various scan parameters, and compute a scanning profile according to corresponding user input. In another such embodiment, controller 600 may comprise a peripheral, such as a joystick, directional pad, or any other mechanism suitable to interpret spatial input, through which a user may identify scan parameters. In some embodiments, optical scanner 230 may further comprise a visible laser beam 250 (or other suitable mechanism) for visually identifying where the scanner is aimed. In one embodiment, a user may operate controller 600 to direct inspection system 100 components in real-time, providing for the ability to conduct a “manual” inspection. In another embodiment, controller 600 may be used to trace all or a portion of a scan profile on object 110, or to identify scan parameters such as scan area, scanner position, and object position, while a user watches the visible laser beam 250 and directs the position and head orientation of optical scanner 230 using the peripheral.

Laser ultrasonic inspection system 100 may be used to inspect an object 110. In operation, object 110 may be placed inside of chamber 300 through opening 320. Object may be placed in any suitable location within chamber 300 including but not limited to, on support structure 330 or object positioning mechanism 400. Visual markers may be used to guide proper placement of object 110. Once the object 110 is positioned, opening 320 may then be closed. Next, a scanning profile may be determined. Controller user interface may be used to select a pre-programmed scanning profile or to input scanning parameters to compute a customized scanning profile. Scanning parameters may be directly entered or selected from predetermined values (list, icons, etc.), or a peripheral may be used to identify scan parameters or a scan profile. If the peripheral is used, controller 600 may be used to maneuver the head orientation of optical scanner 230 and its position via scanner positioning mechanism 500, as well as to control the position and orientation of object 110 via object positioning mechanism 400. A visible laser tracer may be used to aim the scanner head. A real-time manual inspection may be conducted in this manner. Alternatively, a scan profile may be defined and recorded. Still further, scan parameters such as scan area, scan position, object position, and sequential combinations thereof may be defined to generate a scan profile. When a scan is conducted, first laser beam 212 may create ultrasonic waves in object 110, and second laser beam 222 may illuminate the object. Reflected portions of the second laser beam 222 may be gathered by optical scanner 230 and passed on to interferometer 250 optically coupled thereto. Interferometer 250 may generate an ultrasonic signal responsive to the reflected beam. More precisely, the interferometer 250 may generate an ultrasonic signal responsive to the phase shift (or correspondingly to the frequency shift) in the reflected portions of second laser beam 222. Such scan data may then be passed on to an analysis station 700 for processing. Output from the analysis station may indicate or be further reduced to indicate the presence of cracks or damage in object 110.

It will also be appreciated that one or more of the elements depicted in the figures can also be implemented in a more separated or integrated manner, or even removed or rendered as inoperable in certain cases, as is useful in accordance with a particular application.

As used in the description herein and throughout the claims that follow, “a,” “an” and “the” include plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in the following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed is:

1. A laser ultrasonic inspection system, comprising:
a first and a second laser source configured to generate a first and a second laser beam;
an optical scanner configured to direct the first and second laser beams onto an object to be inspected;
an interferometer optically coupled to the optical scanner, the interferometer configured to receive light reflected by the object and to generate an electrical signal in response to the reflected light; and
an inspection chamber for housing the object to be inspected, the inspection chamber configured to restrict outside exposure to radiation from the first and second laser beams;
wherein the first laser beam generates ultrasonic waves in the object and the second laser beam illuminates the object.

2. The system of claim 1, further comprising a controller configured to control the optical scanner to direct the first and second laser beams.

3. The system of claim 1, further comprising a scanner positioning mechanism to which the optical scanner is coupled, the scanner positioning mechanism configured to movably position the optical scanner within the inspection chamber.

4. The system of claim 3 further comprising a controller configured to control the position of the optical scanner within the inspection chamber via the positioning mechanism.

5. The system of claim 1, wherein the inspection chamber comprises an aperture for viewing the interior of the chamber.

6. The system of claim 5, wherein the aperture comprises a window.

7. The system of claim 1, wherein the inspection chamber further comprises a camera for viewing an interior portion of the chamber.

8. The system of claim 1, wherein the inspection chamber comprises an object support structure for supporting the object to be inspected.

9. The system of claim 8, wherein the object support structure comprises one or more visual indicators to assist in positioning the object thereon.

10. The system of claim 3, further comprising an object positioning mechanism within the inspection chamber.

11. The system of claim 10, further comprising a controller configured to control the position of the object positioning mechanism.

12. The system of claim 10, further comprising a controller configured to automatically control the optical scanner to direct the first and second laser beams, the position of the optical scanner within the inspection chamber via the positioning mechanism, and the position of the object positioning mechanism according to a programmed scanning profile.

13. The system of claim 1, wherein the optical scanner is configured to direct a visible laser tracer, the visible laser tracer being representative of the orientation of the first and second laser beams as directed by the optical scanner.

14. The system of claim 12, wherein all or part of a scanning profile is defined according to real-time user inputs to a controller configured to control the optical scanner, the position of the optical scanner, and the position of the object positioning system, the real-time user inputs being guided with the assistance of a visible laser tracer representative of the orientation of the first and second laser beams as directed by the optical scanner.

15. The system of claim 1, wherein a ratio of an interior volume of the inspection chamber to a scan volume is less than 20.

16. A laser ultrasonic inspection system, comprising:
an inspection chamber for housing an object to be inspected;
a first and a second laser source configured to generate a first and a second laser beam, the first and the second laser sources being disposed outside of the inspection chamber, wherein the first laser beam generates ultrasonic waves in the object and the second laser beam illuminates the object;
an optical scanner configured to direct the first and second laser beams onto the object to be inspected, the optical scanner being disposed within the inspection chamber;
a visible laser tracer representative of the orientation of the first and second laser beams;
an interferometer optically coupled to the optical scanner, the interferometer configured to receive light reflected by the object and to generate an electrical signal in response to the reflected light;
a scanner positioning mechanism configured to movably position the optical scanner within the inspection chamber; and
an object positioning mechanism configured to movably position the object within the inspection chamber.

17. A method for inspecting an object, comprising the steps of:
positioning an object inside of an inspection chamber;
defining a scanning profile, comprising the sub-steps of:
defining one or more scan areas; and
defining one or more positions for an optical scanner; and
directing a first and a second laser beam onto the object according to the scanning profile.

18. The method of claim 17, wherein the step of defining a scanning profile comprises selecting a pre-programmed scanning profile.

19. The method of claim 17, wherein the step of defining a scanning profile comprises real-time user inputs to a controller configured to control the optical scanner and the one or more positions for the optical scanner.

20. The method of claim 19, wherein the step of defining a scanning profile further comprises providing a visible laser tracer representative of the orientation of the first and second laser beams to assist with the real-time user inputs.

21. The method of claim 17, wherein the step of defining a scanning profile comprises selecting one or more scanning parameters from a user-selectable list.

22. The method of claim 21, wherein the one or more scanning parameters may be selected from the group consisting of: scan area, scan pattern, optical scanner position, optical scanner head orientation, and object position.

23. The method of claim 17, wherein the step of defining a scanning profile comprises the additional sub-step of defining a scan pattern.

24. The method of claim 17, wherein the step of defining a scanning profile comprises the additional sub-step of defining one or more orientations of the optical scanner.

25. The method of claim 17, wherein the step of defining a scanning profile comprises the additional sub-step of defining one or more positions for the object.

26. The method of claim 17, wherein a ratio of an interior volume of the inspection chamber to a scan volume is less than 20.
